(19) United States
(12) Patent Application Publication
(10) Pub. No.: US 2026/0227841 A1
(43) Pub. Date: Aug. 6, 2026

(54) CONTEXTUAL POWER MANAGEMENT

(71) Applicant: Apple Inc., Cupertino, CA (US)

(72) Inventors: Archana VENKATESH, Santa Clara, CA (US); Kartik R. VENKATRAMAN, San Francisco, CA (US); Prateek MALHOTRA, San Francisco, CA (US)

(73) Assignee: Apple Inc., Cupertino, CA (US)

(21) Appl. No.: 19/043,256

(22) Filed: Jan. 31, 2025

(51) Int. Cl. G06F 1/3228

(52) U.S. Cl. CPC G06F 1/3228

(57) ABSTRACT

Some embodiments include leveraging user behaviors of a computing device to adjust operations of subsystems of the computing device. Some embodiments determine scenarios of interest, and enable implementation of an alternate set of subsystem policies that provide a better user experience without the user explicitly making a selection of a particular mode. In other words, a user's goal or a user's strong implicit expectation can be determined by a user's current actions, system context, and/or predictions based on the user's past device usage (e.g., routines, patterns, and/or heuristics). Based on the determination, various subsystem operation policies are adjusted accordingly to satisfy the user's goal or strong implicit expectation such as having a cooler device, charging faster, or performing slower.

### BACKGROUND OF THE INVENTION

### Field of the Invention

The embodiments relate generally to managing power based on contextual information.

### BRIEF SUMMARY OF THE INVENTION

Some embodiments include a system, apparatus, method, and computer program product for contextual power management. Some embodiments include a processor (or one or more processors) that can determine a goal based at least on user actions, device context, and predictions of the computing device. Based at least on the goal, the processor can determine one or more policies that affects one or more corresponding subsystems, and transmit a signal to enable a policy of the one or more policies. To determine the goal, the processor can determine that the computing device is in use, and determine a charging state of the computing device.

In some examples, the one or more policies include a reduction in a charging rate of a charging subsystem of the one or more corresponding subsystems, and a reduction in background activity of a background activity subsystem of the one or more corresponding subsystems. To reduce the charging rate, the processor can determine that an in-use threshold has been satisfied, where the in-use threshold corresponds to: a temperature of the computing device, an in-use time period, an in-use time prediction, a workload, or a type of application running on the computing device. To reduce the background activity of the computing device, the processor can establish a time duration during which no background activity is scheduled, or reduce a scheduling priority of background activity compared to in-use activity.

In some embodiments, the processor can determine that the computing device is not in a typical charging location, and reduce a power target of a performance controller (e.g., a closed loop performance controller (CLPC). In some examples, the processor can prioritize sustained performance of the computing device, and reduce a power target of a CLPC. Based at least on the prioritized sustained performance, the processor can allow an increase in temperature of the computing device.

In some embodiments, a method for a computing device can include determining a goal based at least on user actions, device context, and predictions of the computing device. Based at least on the goal, the method can include determining one or more policies that affect one or more corresponding subsystems, and transmitting a signal to enable a policy of the one or more policies. In some examples, the determining the goal can include determining that the computing device is not in use, and predicting that a long plugin charge is forthcoming (e.g., a long plugin charge can be a duration of greater than 90 minutes).

The one or more policies can include a reduction in a charging rate of the computing device, an increase in a background activity of the computing device, and a reduction in a power target of a performance controller. As an example, the reduction in the power target of the performance controller corresponds to a value in a range of 1 W to 3 W. In some examples, the method can include prioritizing background activity of the computing device, and allow an increase in temperature of the computing device. Some embodiments can include prioritizing lower thermals of the computing device, and reducing a temperature of the computing device.

Some embodiments can include a non-transitory computer-readable medium storing instructions that, upon execution by one or more processors of a computing device, cause the computing device to perform operations. The operations can include determining a goal based at least on user actions, device context, and predictions of the computing device. Based at least on the goal, the operations can include determining one or more policies that affect one or more corresponding subsystems, and transmitting a signal to enable a policy of the one or more policies.

In some embodiments, to determine the goal, the operations include determining that the computing device is not in use, determining a charging state of the computing device, and predicting that a short plugin charge is forthcoming. In some examples, the charging state comprises a state of charge of a battery of the computing device of less than or equal to 50%. In some examples, the short plugin charge can be a duration of less than or equal to than 90 minutes. In some examples, the one or more policies includes an increase in a charging rate of a charging subsystem of the one or more corresponding subsystems, a reduction in a background activity of a background activity subsystem of the one or more corresponding subsystems, and a reduction in a power target of a performance subsystem of the one or more corresponding subsystems. A reduction of the power target of the performance subsystem can correspond to a value in a range of 300 mW to 1 W. Some embodiments include operations prioritizing charging of the computing device, and allow an increase in temperature of a thermal subsystem of the one or more corresponding subsystems according to the policy.

### BRIEF DESCRIPTION OF THE DRAWINGS/FIGURES

The accompanying drawings, which are incorporated herein and form part of the specification, illustrate the presented disclosure and, together with the description, further serve to explain the principles of the disclosure and enable a person of skill in the relevant art(s) to make and use the disclosure.

FIG. 1 illustrates an example system supporting contextual power management, in accordance with some embodiments of the disclosure.

FIG. 2 illustrates an example diagram of an architecture supporting contextual power management, in accordance with some embodiments of the disclosure.

FIG. 3 illustrates an example of contextual power management, according to some embodiments of the disclosure.

FIG. 4 illustrates an example of in-use charging mode contextual power management, according to some embodiments of the disclosure.

FIG. 5 illustrates an example of long charging mode contextual power management, according to some embodiments of the disclosure.

FIG. 6 illustrates an example of accelerated charging mode contextual power management, according to some embodiments of the disclosure.

FIG. 7 illustrates a method for contextual power management, according to some embodiments of the disclosure.

FIG. 8 illustrates a method for contextual power management based on goals, according to some embodiments of the disclosure.

FIG. 9 illustrates a method for in-use charging mode contextual power management, according to some embodiments of the disclosure.

FIG. 10 illustrates a method for long charging mode contextual power management, according to some embodiments of the disclosure.

FIG. 11 illustrates a method for accelerated charging mode contextual power management, according to some embodiments of the disclosure.

FIG. 12 is an example computer system for implementing some embodiments or portion(s) thereof.

The presented disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION OF THE INVENTION

Some embodiments include a system, apparatus, article of manufacture, method, and/or computer program product and/or combinations and sub-combinations thereof, for contextual power management on a computing device. Some embodiments include leveraging user behaviors of a computing device to adjust operations of subsystems of the computing device. Some embodiments determine scenarios of interest, and enable implementation of an alternate set of subsystem policies that provide a better user experience without the user explicitly making a selection of a particular mode. In other words, a user's goal or a user's strong implicit expectation can be determined by a user's current actions, device context, and/or predictions based on the user's past device usage (e.g., routines, patterns, and/or heuristics). Based on the determination, various subsystem operation policies are adjusted accordingly to satisfy the user's goal or strong implicit expectation such as having a cooler device, charging faster, and/or performing slower.

Some embodiments enable contextual power management in the thermal, performance, and/or battery domains, especially where lower level subsystems may not be able to determine the context in which a computing device is operating. For example, in the thermal domain, some embodiments enable contextual power management to actively reprioritize the thermal headroom (e.g., the power consumption budget) that corresponds to temperature mitigation based on: user actions, predictions based on a user's past usage, and/or device context. Some embodiments enable contextual power management in the performance domain. For example, some embodiments enable a more active determination on whether a computing device directs a higher performance to foreground work versus background work. In the battery domain, some embodiments include enabling contextual power management to adjust the charging rate of the computing device.

Well-defined user scenarios include central determinations of a user's intent, a user's priority, and/or a user's strong implicit expectation when using the computing device, and what the computing device should do in response. Based at least on those determinations, some embodiments enable adjustments of subsystems to enable a computing device to perform to match (e.g., satisfy) the user's strong implicit expectation resulting in a better overall experience with the computing device. Some embodiments enable a scalable solution that can adjust to new applications that become available in that additional determinations can be made, and corresponding adjustments to the subsystems can be made.

For example, charging while using a computing device and charging the computing device at the airport (e.g., an atypical charging location), are different than charging the computing device overnight (e.g., at a typical charging location). There is a limited thermal headroom (e.g., a power consumption budget that corresponds to a rise in temperature of a computing device). The power consumption budget can be distributed amongst foreground work (e.g., something the user is currently paying attention to), background work (e.g., activities that occur without the user's explicit focus), and charging (e.g., the computing device heats up when charging). How the power consumption budget and hence the amount of thermal energy is distributed to those features affect corresponding subsystems.

Thermal headroom can refer to power consumption in an ambient environment that is relatively warm and cold. A computing device used outside in warmer weather can consume less power before the computing device heats up to an unsafe level. When the computing device is used outside in colder weather, more power can be consumed by the computing device before the device heats up to the unsafe level. Not counting the ambient temperature effects, the actual power consumed is controlled by the computing device. Various subsystems compete for the power resources (e.g., the power consumption budget) and the subsystems' power usage contribute to the increased temperature of the device. Some computing devices are designed to operate up to a maximum temperature (e.g., 50° C.). Given a temperature, various subsystems will change operating policies to reduce power consumption (e.g., to reduce power usage corresponding to lowering a temperature rise of the computing device). And the subsystems may reduce power consumption according to a particular order. But, the participating subsystems may operate at a lower layer of protocol and cannot determine what a user's priority is when using the computing device, or what the user's strong implicit expectation of how the computing device should perform at a given time. Accordingly, some embodiments enable contextual power management based on user actions, device context, and predictions based on historical usage of the computing device, especially where lower level subsystems may not be able to determine the context in which a computing device is operating.

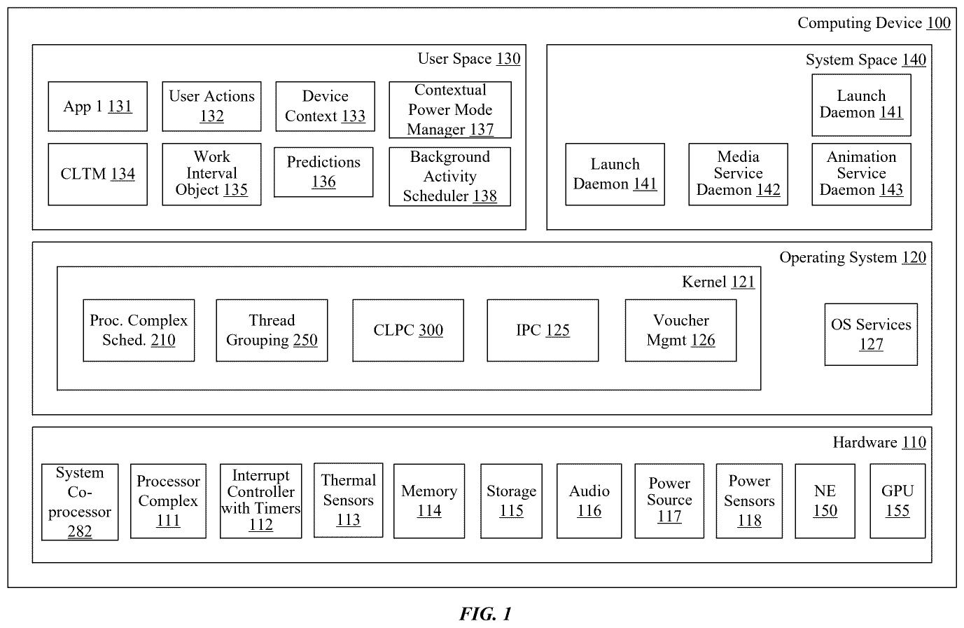

FIG. 1 illustrates an example system supporting contextual power management, in accordance with some embodiments of the disclosure. The example system can be a computing device 100, for example. Computing device 100 can process threads having thread groups on a processor including a plurality of core types, each having one or more cores, according to some embodiments. Computing device 100 can include hardware 110, operating system 120, user space 130, and system space 140.

Some examples include controlling system performance using measurements of performance metrics of groups of threads to make joint decisions on scheduling of threads and dynamic voltage and frequency scaling (DVFS) state(s) for one or more clusters of cores in a multiprocessing system having a plurality of core types and one or more cores of each core type. The performance metrics can be fed into a closed loop control system that produces an output that is used to jointly decide how fast a core is to run and on which core type the threads of a thread group are to run. A thread group comprises one or more threads that are grouped together based on one or more characteristics that are used to determine a common goal or purpose of the threads in the thread group. Some examples include minimizing thread scheduling latency for performance workloads, ensuring that performance workloads consistently find a performance core, maximizing throughput for performance workloads, and ensuring that efficiency workloads always find an efficient core. Some examples can further include ensuring that cores are not powered down when threads are queued for processing, and offloading performance workloads when performance cores are oversubscribed. Threads are systematically guided to cores of the correct type for the workload.

Hardware 110 can include a processor complex 111 with a plurality of core types or multiple processors of differing types. Processor complex 111 can comprise a multiprocessing system having a plurality of clusters of cores, each cluster having one or more cores of a core type, interconnected with one or more buses. Processor complex 111 can comprise a symmetric multiprocessing system (SMP) having a plurality of clusters of a same type of core, wherein at least one cluster of cores is configured differently from at least one other cluster of cores. Cluster configurations can include, e.g., different configurations of dynamic voltage and frequency scaling (DVFS) states, different cache hierarchies, or differing amounts or speeds of cache.

Processor complex 111 or a central processing unit (CPU) can additionally comprise an asymmetric multiprocessing system (AMP) having a plurality of clusters of cores wherein at least one cluster of cores has a different core type than at least one other cluster of cores. Each cluster can have one or more cores. Core types can include performance cores (P-cores), efficiency cores (E-cores), graphics cores, digital signal processing cores, and arithmetic processing cores. In an embodiment, processor complex 111 can comprise a system on a chip (SoC) that may include one or more of the hardware elements in hardware 110. In some embodiments, hardware 110 can include graphics processing unit (GPU) 155. In some embodiments, hardware 110 can include a neural engine (NE) 150, a high-performance, power/area efficient Deep Neural Network hardware accelerator.

A performance core can have an architecture that is designed for very high throughput and can support a higher operating frequency compared to an efficiency core. A performance core may consume more energy per instruction than an efficiency core. An efficient core may consume less energy per instruction than a performance core.

Hardware 110 can further include an interrupt controller 112 having interrupt timers for each core type of processor complex 111. Hardware 110 can also include one or more thermal sensors 113. In an embodiment, wherein processor complex 111 comprises an SoC, one more thermal sensors 113 can be included in the processor complex 111. In an embodiment, at least one thermal sensor 113 can be included on processor complex 111 for each core type of the processor complex 111. In an embodiment, a thermal sensor 113 can comprise a virtual thermal sensor 113. A virtual thermal sensor 113 can comprise a plurality of physical thermal sensors 113 and logic that estimates one or more temperature values at location(s) other than the location of the physical thermal sensors 113.

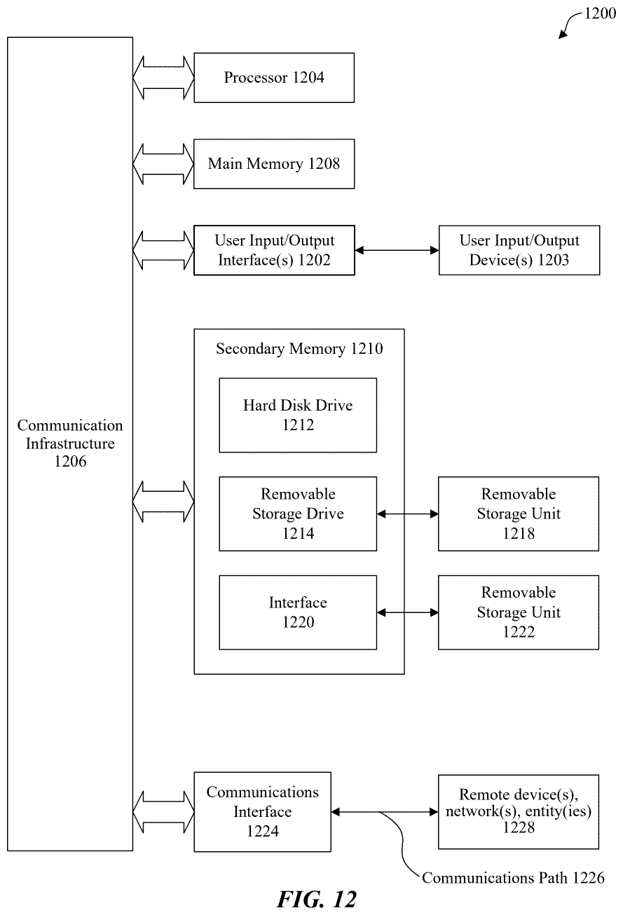

Hardware 110 can include system co-processor 282 that can control the temperature of computing device 100 as well as the charging rate (e.g., charging speed) of computing device 100. Hardware 110 can additionally include memory 114, storage 115, audio 116, one or more power sources 117, and one or more energy and/or power consumption sensors 118. Memory 114 can be any type of memory including dynamic random-access memory (DRAM), static RAM, read-only memory (ROM), flash memory, or other memory device. Storage can include hard drive(s), solid state disk(s), flash memory, USB drive(s), network attached storage, cloud storage, or other storage medium. Audio 116 can include an audio processor that may include a digital signal processor, memory, one or more analog to digital converters (ADCs), digital to analog converters (DACs), digital sampling hardware and software, one or more coder-decoder (codec) modules, and other components. Hardware can also include video processing hardware and software (not shown), such as one or more video encoders, camera, display, and the like. Power source 117 can include one or more storage cells or batteries, an AC/DC power converter, or other power supply. Power source 117 may include one or more energy or power sensors 118. Power sensors 118 may also be included in specific locations, such as power consumed by the processor complex 111, power consumed by a particular subsystem, such as a display, storage device, network interfaces, and/or radio and cellular transceivers. Computing device 100 can include the above components, and/or components as described with reference to FIG. 12, below.

Operating system 120 can include a kernel 121 and other operating system services 127. Kernel 121 can include a processor complex scheduler 210 for the processor complex 111. Processor complex scheduler 210 can include interfaces to processor complex 111 and interrupt controller 112. Kernel 121, or processor complex scheduler 210, can include thread group logic 250 that enables the closed loop performance controller (CLPC) 300 to measure, track, and control performance of threads by thread groups. CLPC 300 can include logic to receive sample metrics from processor complex scheduler 210, process the sample metrics per thread group, and determined a control effort (CE) needed to meet performance targets for the threads in the thread group. CLPC 300 can recommend a core type and DVFS state for processing threads of the thread group. Inter-process communication (IPC) module 125 can facilitate communication between kernel 121, user space 130, and system space 140.

In an embodiment, IPC module 125 can receive a message from a thread that references a voucher. A voucher is a collection of attributes in a message sent via inter-process communication from a first thread, T1, to a second thread, T2. One of the attributes that thread T1 can put in the voucher is the thread group to which T1 currently belongs. IPC module 125 can pass the voucher from a first thread to a second thread. The voucher can include a reference to a thread group that the second thread is to adopt before performing work on behalf of the first thread. Voucher management 126 can manage vouchers within operating system 120, user space 130, and system space 140. Operating system (OS) services 127 can include input/output (I/O) service for such devices as memory 114, storage 115, network interface(s) (not shown), and a display (not shown) or other I/O device. OS services 127 can further audio and video processing interfaces, data/time service, and other OS services.

User space 130 can include one or more application programs (e.g., App 1 131), closed loop thermal management (CLTM) 134, one or more work interval object(s) 135, User Actions 132, Device Context 133, Predictions 136, Contextual Power Mode Manager 137, and Background Activity Scheduler 138.

CLTM 134 can monitor a plurality of power consumption and temperature metrics at a system-level, and feed samples of the metrics into a plurality of tunable controllers. The output of the CLTM 134 can determine a processor complex average power target used as input to a control effort limiter (CEL) a system-level, to determine a limit on a CE that is output by CLPC 300. The control effort limit can be used to limit the type of cores, number of cores of each type, and DVFS state for the cores for the processor complex 111. A work interval object 135 is used to represent periodic work where each period has a deadline. The work interval object 135 possesses a token and a specified time interval for one instance of the work. Threads that perform work of a particular type, e.g. audio compositing, and the work must be completed in a specified interval of time, e.g. a frame rate of audio, can be associated with the work interval object 135. User space 130 can include a plurality of work interval objects 135. A work interval object 135 can have its own thread group, as may be specified in source code, compiled code, or a bundle of executables for execution. Threads that perform work on behalf of the work interval object 135 can opt-in to the thread group of the work interval object 135. For threads that have opted-in and adopted the thread group of the work interval object 135, work performed by the threads, on behalf of the work interval object 135, is associated with the thread group of the work interval object 135 for purposes of CLPC 300 operation.

Some embodiments include leveraging user behaviors to adjust subsystem behaviors. In some examples, contextual power mode manager 137 can determine a goal (e.g., a user's intention while using computing device 100) based a user's current actions including user actions 132, device context 133, and predictions 136 based on a user's past behaviors (e.g., routines), especially where the subsystems are not able to detect and/or determine the contextual usage of computing device 100. Contextual power mode manager 137 can translate the goal into a mode that corresponds to a unique combination of defined operating policies for subsystems. In other words, a mode can cause a change in subsystem behaviors that satisfy the user's goal.

System space 140 can include a launch daemon 141 and other daemons, e.g. media service daemon 142 and animation daemon 143. In an embodiment, threads that are launched by a daemon that perform a particular type of work, e.g. daemons 142 and 143, can adopt the thread group of the daemon. Execution metrics of a thread that adopted the thread group of the daemon that launched the thread are attributable to the thread group of the daemon for purposes of CLPC 300 operation.

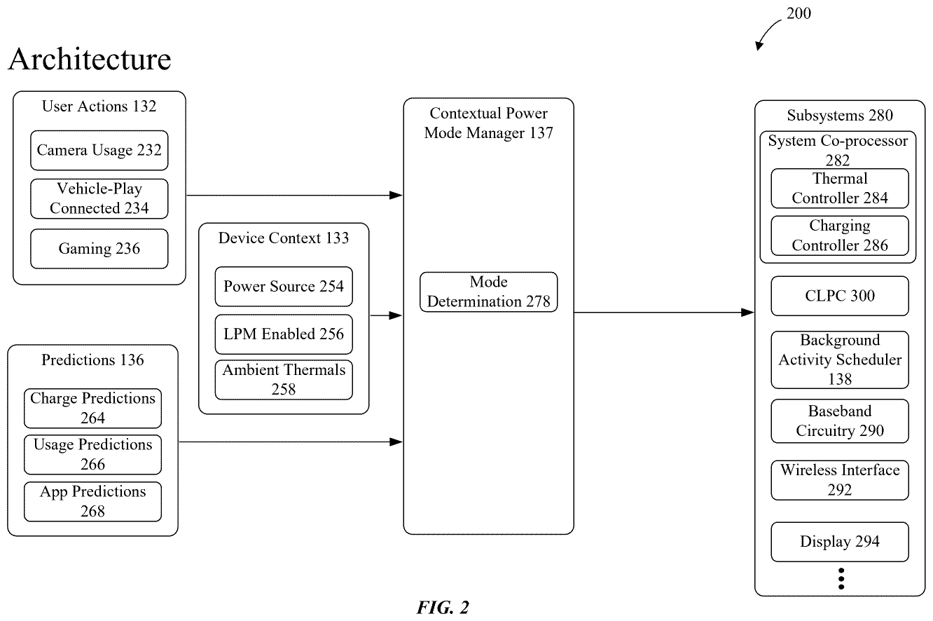

FIG. 2 illustrates an example diagram 200 of an architecture supporting contextual power management, in accordance with some embodiments of the disclosure. As a convenience and not a limitation, FIG. 2 may be described with reference to elements from other figures in the disclosure. For example, FIG. 2 can describe, at a high level, interactions between subsystems described above, with reference to FIG. 1. Diagram 200 can include user actions 132, device context 133, predictions 136, contextual power mode manager 137 supported by one or more processors of processor complex 111 of FIG. 1. Diagram 200 also includes subsystems 280 supported by one or more processors of system co-processor 282 and/or one or more processors of processor complex 111.

User actions 132 can determine in-use activity being performed on computing device 100 including but not limited to determining: camera usage 232, vehicle-play usage 234 where an automotive head unit is communicatively coupled to the device, and/or gaming usage 236 (e.g., when a user is using an AAA gaming application or an application that utilizes high/intense processing resources), and/or applications in user space 130 of FIG. 1 such as App 1 131 (e.g., navigation, audio playback, video playback).

Device context 133 can determine the context in which computing device 100 is operating including but not limited to determining: power source 254 (e.g., power source 117 of FIG. 1 can be battery or wired), low power mode (LPM) enabled 256 (e.g., to conserve battery power), and ambient thermals 258 adjusts temperature readings to accommodate effects of the temperature of the environment in which computing device 100 is operating (e.g., in a pocket, indoors in cool temperatures, outside on a hot day, or in a vehicle on a sunny day).

Predictions 136 include but are not limited to a user's routine predictions regarding: Charge predictions 264 (e.g.., charging frequency and/or charging duration), usage predictions 266 (e.g., activity/inactivity patterns), and app predictions 268 (e.g., frequency, duration, and routines for using certain applications). In some examples, the predictions can be made by device machine learning models built based on the user's historical usage data corresponding to computing device 100.

For various combinations of user actions 132, device contexts 133, and predictions 136, contextual power mode manager 137 can determine a goal. The goal reflects the user's strong implicit expectation, and mode determination 278 can translate the goal into a mode that can affect the policies of one or more subsystems 280 to enable a better user experience with computing device 100. Further, the mode can be enacted without the user taking any explicit actions to initiate the mode that affects the policies of the one or more subsystems 280.

Examples of subsystem policies that affect subsystems 280 can include but are not limited to the following: Cause a change in system co-processor 282 such as i) cause thermal controller 284 to adjust a temperature of computing device 100; and/or ii) cause charging controller 286 to adjust to a faster charge rate or a slower charge rate; cause a performance controller (e.g., closed loop performance controller (CLPC 300) to adjust the power usage for the system on a chip (SoC) to reduce or increase performance; cause background activity scheduler 138 to adjust background activities (e.g., by changing a priority of background work of threads); cause a change in operation of baseband circuitry 290 (e.g., change a frequency of operation); cause a change in operation of wireless interface 292 (e.g., turn off Bluetooth™); and/or cause a change in operation of display 294 (e.g., reduce brightness).

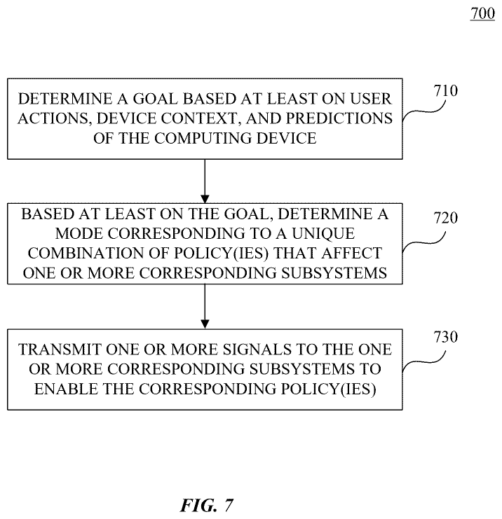

FIG. 7 illustrates method 700 for contextual power management, according to some embodiments of the disclosure. As a convenience and not a limitation, FIG. 7 may be described with reference to elements from other figures in the disclosure. For example, FIG. 7 can describe, at a high level, interactions between subsystems described above, with reference to FIGS. 1-2. In some embodiments, one or more processors of processor complex 111 can support the functions of contextual power mode manager 137 that performs method 700.

At 710, contextual power mode manager 137 can receive signals from user actions 132, device context 133, and/or predictions 136. Based at least on the signal received, contextual power mode manager 137 (e.g., mode determination 278) can determine a goal that can reflect a user's strong explicit expectation.

At 720, contextual power mode manager 137 (e.g., mode determination 278) can determine a mode that corresponds to a unique combination of one or more policies, where the one or more policies correspond to one or more subsystems 280. The policies of the unique combination of policies can cause a change in the operation of the corresponding one or more subsystems 280. The combination of the changes can improve the user's experience with computing device 100.

At 730, contextual power mode manager 137 can transmit signals corresponding to the corresponding one or more subsystems 280 to enable the determined policy(ies).

Table 1 below illustrates goals, modes, and corresponding policy changes to one or more subsystems 280 (e.g., charging controller 286, thermal controller 284, CLPC 300, and/or background activity scheduler 138) as determined by contextual power mode manager 137 (that includes mode determination 278). For example, contextual power mode manager 137 can receive signals from user actions 132, device context 133, and/or predictions 136. Based at least on the received signals, mode determination 278 can determine a goal and/or a prioritization that reflects a user's strong implicit expectation including but not limited to the following: Performance and thermal perception, background activity, charging, sustained performance, connection to vehicle head unit, and lower thermals.

TABLE 1
Goal, Mode, and Corresponding Policy Changes

| Goal- | | Charging | Thermal | Package | |
|---|---|---|---|---|---|
| Prioritization | Mode | Speed | Target | Power Target | Background Activity |
| Performance | In-use Charging | Decrease | — | — | Decrease |
| and thermal | | | | | |
| perception | | | | | |
| Background | Long | Decrease | Increase | Decrease | Increase |
| activity | Charging | | | | |
| Charging | Accelerated | Increase | Increase | Decrease | Decrease |
| | Charging | | | | |
| Sustained | Gaming | Decrease | Increase | Decrease | Decrease |
| performance | | | | | |
| Connection to | Vehicle- | Decrease | — | Decrease | Decrease |
| vehicle head | Play | | | | |
| unit | | | | | |
| Lower | Post Restore | Decrease | Decrease | Decrease | Increase |
| thermals | Inactive | | | | |

In some examples, a goal can be a well-defined user scenario or a scenario of interest. Once a goal is determined by contextual power mode manager 137, mode determination 278, can translate the goal to a mode corresponding to a unique combination of subsystem 280 policies. Contextual power mode manager 137 transmit signal(s) to corresponding subsystems to enable the unique combination of policies that together cause changes in subsystem performances (e.g., behaviors) to achieve a better experience for the user using computing device 100. Some examples of changes in the thermal domain include adjusting the temperature of computing device 100 by controlling the power distributed to various subsystems 280 (e.g., system co-processor 282, thermal controller 284, charging controller 286). Some examples of changes in the performance domain include adjusting policies for background activity scheduler 138 and/or performance subsystem (e.g., CLPC 300) operations. In some examples, policies for changing background activity scheduler 138 behavior can include but is not limited to changing the setting of background activities to default, restrictive, and/or aggressive settings. Some examples of performance subsystem (e.g., CLPC 300) policies include but is not limited to changing target performance settings such as maximum performance, sustained performance, and/or reduced performance. Some examples of policies that can change in the battery domain include adjusting charging controller 286 including but is not limited to changing a charging rate of the device. Charging rate settings can include standard, fast, and/or slow, for example. In some examples, the settings may include a number of settings, N, where N is an integer, and contextual power mode manager 137 can select the mode corresponding to the unique combination of subsystem policies including the corresponding setting from 0 to N.

In some embodiments, the determination of a goal can be rule driven based at least on a combination of: a detection of certain user actions, a detection of certain device contexts, and/or the determination of certain predictions.

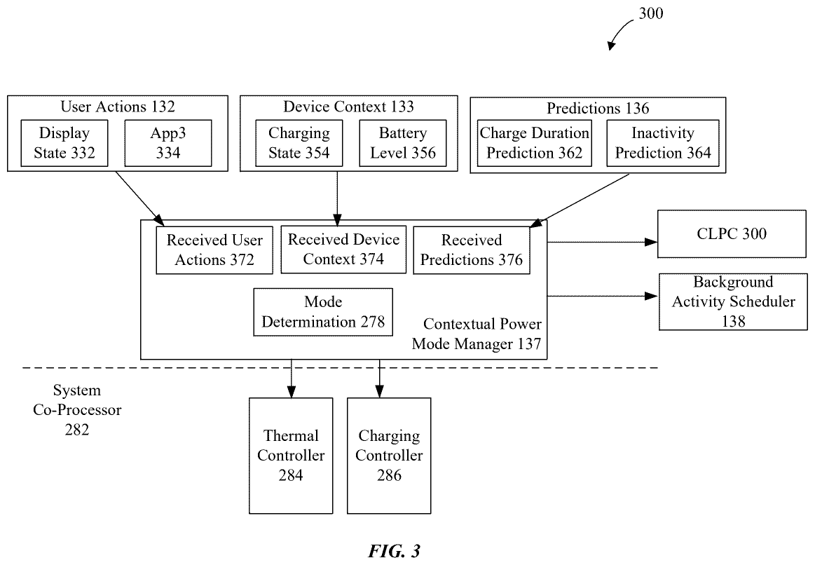

FIG. 3 illustrates example 300 of contextual power management, according to some embodiments of the disclosure. As a convenience and not a limitation, FIG. 3 may be described with reference to elements from other figures in the disclosure such as FIGS. 1-2. Example 300 can include user actions 132, device context 133, predictions 136, contextual power mode manager 137, mode determination 278, CLPC 300, and background activity scheduler 138 supported by one or more processors of processor complex 111. In some embodiments, thermal controller 284 and/or charging controller 286 can be supported by one or more processors of system co-processor 282 and/or one or more processors of processor complex 111. Examples of user actions 132 can include an indication that display state 332 is in an ON or OFF state and/or an application such as App3 334 is in the ON or OFF state. Other examples of user actions 132 determining that computing device 100 is in active use include determining: if the user is using computing device 100 for greater than 30 seconds, that the display is on, that computing device 100 is unlocked, or whether App3 334 (e.g., vehicle-play application) is active. User Actions 132 can transmit a signal(s) to received user actions 372 of contextual power mode manager 137 indicating whether a user is using computing device 100.

Examples of device context 133 can include charging state 354 and battery level 356. Examples of charging state 354 can include whether computing device 100 is in a charging state or not, and examples of battery level 356 can include a percentage of state of charge (e.g., 20%, 50%). In some examples, device context 133 can indicate whether computing device 100 is: being charged, running on battery, operating at an acceptable temperature (e.g., not too hot, less than 43° C.), and/or operating with LPM enabled. Device context 133 can transmit a signal(s) to received device context 374 of contextual power mode manager 137 indicating corresponding device context information.

The user actions 132 and device context 133 and combinations can be analyzed to determine what a user's routine is and can provide insights on predictions on the user's future use with computing device 100. Examples of predictions 136 can include charge duration prediction 362 and inactivity prediction 364. Predictions 136 can transmit a signal(s) to received predictions 376 indicating a predicted charge duration (e.g., short plugin time or long plugin time based on historical data usage) and/or a corresponding time duration window when the predicted charge duration is expected (e.g., within an hour). The transmitted signal(s) can include a prediction for activity and/or inactivity for computing device 100 and/or a time duration window when computing device 100 is expected to become active or inactive.

Based on the information from received user actions 372, received device context 324, and perceived predictions 376, mode determination 278 can determine a corresponding goal that reflects the user's priority for using computing device 100. Based on the goal, mode determination 278 can determine a mode that corresponds to a unique combination of subsystem policies that can enable computing device to provide a better experience for the user, without the user having to make any explicit requests for the unique combination of subsystem policies.

Contextual power mode manager 137 can transmit signal(s) to corresponding subsystems 280 to enable the subsystem policies of the unique combination. In example 300, signals can be transmitted to thermal controller 284, charging controller 286, CLPC 300, and/or background activity scheduler 138. Signals to charging controller 286 can include but are not limited to standard, fast, and/or slow charging rates. Signals to thermal controller 284 can include but are not limited to increasing or decreasing the temperature set point at which the charge rate is modified. Signals to CLPC 300 can include but are not limited to changing target performance settings via policies to a maximum performance (e.g., increase package power target), a sustained performance (e.g., default package power target), and/or reduced performance (e.g., reduce package power target). Signals to background activity scheduler 138 can include but are not limited to changing background activities to a default policy, a restrictive policy (e.g., reduce background activities) and/or an aggressive policy (e.g., increase background activities).

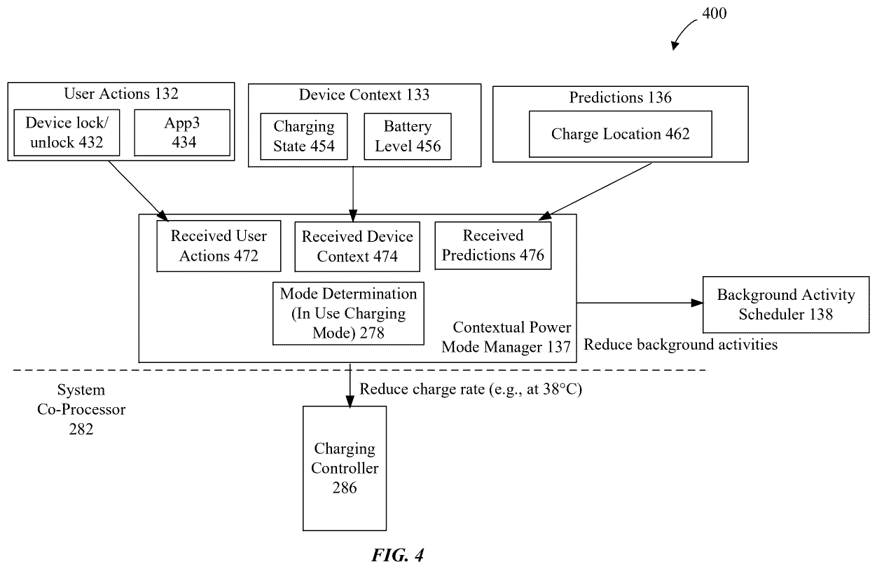

FIG. 4 illustrates example 400 of in-use charging mode contextual power management, according to some embodiments of the disclosure. As a convenience and not a limitation, FIG. 4 may be described with reference to elements from other figures in the disclosure such as FIGS. 1-3. Example 400 can include user actions 132, device context 133, predictions 136, contextual power mode manager 137, mode determination 278, and background activity scheduler 138 supported by one or more processors of processor complex 111 of FIG. 1. Example 400 can also include charging controller 286 supported by one or more processors of system co-processor 282 and/or one or more processors of processor complex 111.,

User actions 132 can include device lock/unlock 432 and/or App3 434 being in an ON or OFF state. In some examples, App3 434 includes a vehicle-play application being in an ON or OFF state. In example 400, user actions 132 determines that at least one of the user actions 132 is active (e.g., in use, active), thus, computing device 100 is in use. Accordingly, user actions 132 can transmit a signal(s) to received user actions 472 of contextual power mode manager 137 indicating that computing device 100 is active and in use.

Device context 133 can include charging state 454 and battery level 456. In example 400, device context 133 determines based on charging state 454 and/or battery level 456 that computing device 100 is being charged and a state of charge is greater than a percentage of state of charge (e.g., 20%). Device context 133 can transmit a signal(s) to received device context 474 of contextual power mode manager 137 indicating corresponding device context information.

Predictions 136 can include charge location 462 that can indicate whether computing device 100 is in a typical charging location such as a location that the user frequents and charges computing device 100 (e.g., home, office, school, restaurant) based on historical usage data corresponding to computing device 100. An atypical location may be a new location in which the user is charging computing device 100, or a location that the user visits infrequently (e.g., an airport) and computing device 100 is being charged. In example 400, predictions 136 determines that computing device 100 is in a typical charging location, and can transmit a signal(s) to received predictions 476 indicating that computing device 100 is in a typical charging location.

Based on the information from received user actions 472, received device context 474, and perceived predictions 476, mode determination 278 can determine a corresponding goal/prioritization for performance and thermal perception that reflects the user's priority for using computing device 100. In other words, the user is actively using computing device 100 in a typical location while charging computing device 100. For example, if computing device 100 is being used actively, some embodiments reduce the charge rate (e.g., slightly reduced) so that computing device 100 does not heat up so as to be uncomfortable in the user's hand. Accordingly, as shown in Table 1 above, based on the goal, mode determination 278 can determine an in-use charging mode that corresponds to a unique combination of subsystem policies that can enable computing device to provide a better experience for the user, without the user having to make any explicit requests for the unique combination of subsystem policies. The corresponding policies call for a decrease in charging speed (e.g., charge rate) as well as a decrease in background activity.

Contextual power mode manager 137 can transmit signal(s) to corresponding subsystems 280 to enable the subsystem policies of the unique combination. In example 400, signal(s) can be transmitted to charging controller 286 to reduce a charge rate (e.g., change to a slow rate). Contextual power mode manager 137 can transmit a signal(s) to background activity scheduler 138 to reduce background activities.

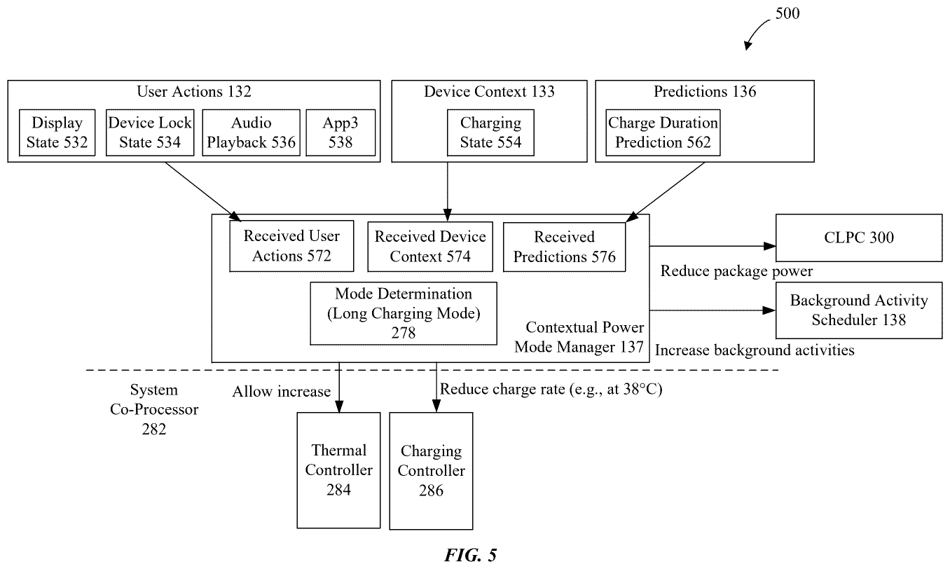

FIG. 5 illustrates example 500 of long charging mode contextual power management, according to some embodiments of the disclosure. As a convenience and not a limitation, FIG. 5 may be described with reference to elements from other figures in the disclosure such as FIGS. 1-3. Example 500 can include user actions 132, device context 133, predictions 136, contextual power mode manager 137, mode determination 278, CLPC 300, and/or background activity scheduler 138 that are supported by one or more processors of processor complex 111. In some embodiments, thermal controller 284 and charging controller 286 can be supported by one or more processors of system co-processor 282 and/or one or more processors of processor complex 111.

User actions 132 can include display state 532 being in an ON or OFF state, device lock/unlock 534 being locked or unlocked, audio playback 536 being in an ON or OFF state, and/or App3 538 being in an ON or OFF state. Audio playback 536 can be in user space 130 of FIG. 1. In example 500, user actions 132 determines that computing device 100 is not in use. Thus, user actions 132 can transmit a signal(s) to received user actions 572 of contextual power mode manager 137 indicating that computing device 100 is not in active use.

Device context 133 can include charging state 554. In example 500, device context 133 determines based on charging state 554 that computing device 100 is being charged. Device context 133 can transmit a signal(s) to received device context 574 of contextual power mode manager 137 indicating corresponding device context information.

Predictions 136 can include charge duration prediction 562 that can indicate whether computing device 100 is predicted to have a long plugin period (e.g., greater than 90 minutes) or a short plugin period (e.g., less than or equal to 90 minutes). In example 500, predictions 136 determines that computing device 100 is predicted to have a long plugin period and can transmit a signal(s) to received predictions 576 indicating that computing device 100 is predicted to have a long plugin period forthcoming.

Based on the information from received user actions 572, received device context 574, and perceived predictions 576, mode determination 278 can determine a corresponding goal/prioritization for background activity that reflects the user's priority for using computing device 100. In other words, the user is not actively using computing device 100, computing device 100 is charging, and a long plugin period is predicted for charging computing device 100. Accordingly, as shown in Table 1 above, based on the goal, mode determination 278 can determine a long charging mode that corresponds to a unique combination of subsystem policies that can enable computing device to provide a better experience for the user, without the user having to make any explicit requests for the unique combination of subsystem policies. The corresponding policies call for a decrease in charging speed (e.g., charge rate), an increase in thermal target temperatures, a decrease in package power target, as well as an increase in background activity.

Contextual power mode manager 137 can transmit signal(s) to corresponding subsystems 280 to enable the subsystem policies of the unique combination. In example 500, signal(s) can be transmitted to thermal controller 284 to allow an increase in the operating temperature of computing device 100. In other words, given that a long charging mode has been determined and computing device 100 is not in use, a user would not notice whether computing device 100 became physically warmer. Contextual power mode manager 137 can also transmit a signal(s) to charging controller 286 to reduce a charge rate. Contextual power mode manager 137 can transmit a signal(s) to CLPC 300 to reduce a package power target (e.g., reduce target power for CLPC 300). Contextual power mode manager 137 can transmit a signal(s) to background activity scheduler 138 to increase background activities. Examples of background work can include loading images to the cloud or other functions that may not have the user's attention (or interest).

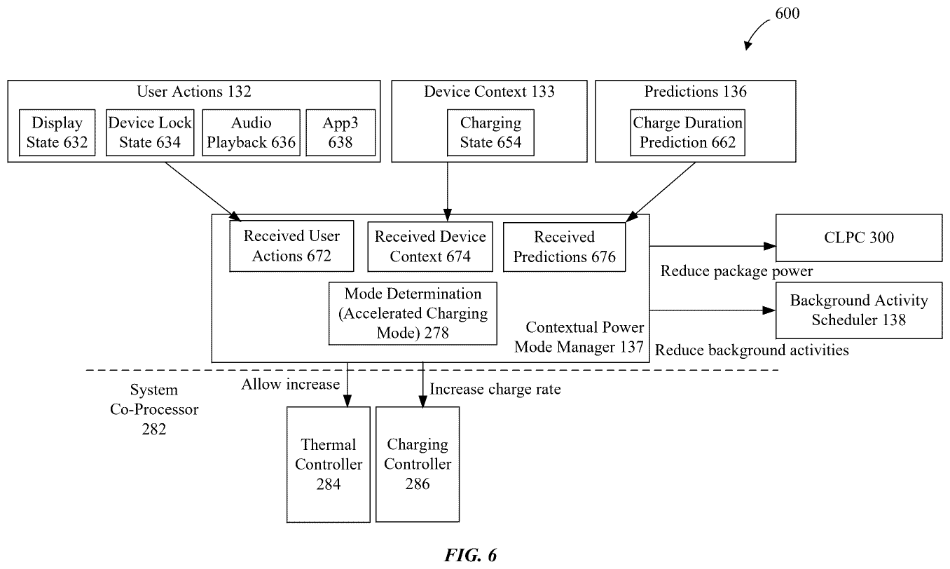

FIG. 6 illustrates example 600 of accelerated charging mode contextual power management, according to some embodiments of the disclosure. As a convenience and not a limitation, FIG. 6 may be described with reference to elements from other figures in the disclosure such as FIGS. 1-3. Example 600 can include user actions 132, device context 133, predictions 136, contextual power mode manager 137, mode determination 278, CLPC 300, and/or background activity scheduler 138 supported by one or more processors of processor complex 111. Example 600 can include thermal controller 284 and charging controller 286 supported by one or more processors of system co-processor 282 and/or one or more processors of processor complex 111.

User actions 132 can include display state 632 being in an ON or OFF state, device lock/unlock 634 being locked or unlocked, audio playback 636 being in an ON or OFF state, and/or App3 638 being in an ON or OFF state. Audio playback 636 can be in user space 130 of FIG. 1. In example 600, user actions 132 determines that computing device 100 is not in use. Thus, user actions 132 can transmit a signal(s) to received user actions 572 of contextual power mode manager 137 indicating that computing device 100 is not in active use.

Device context 133 can include charging state 654. In example 600, device context 133 determines based on charging state 654 that computing device 100 is being charged. In some embodiments, device context 133 can include battery level 656 (not shown) where the state of charge is less than or equal to than a percentage of state of charge (e.g., less than or equal to 50%). Device context 133 can transmit a signal(s) to received device context 674 of contextual power mode manager 137 indicating corresponding device context information.

Predictions 136 can include charge duration prediction 662 that can indicate whether computing device 100 is predicted to have a long plugin period (e.g., greater than 90 minutes) or a short plugin period (e.g., less than or equal to 90 minutes). In example 600, predictions 136 determines that computing device 100 is predicted to have a short plugin period and can transmit a signal(s) to received predictions 676 indicating that computing device 100 is predicted to have a short plugin period forthcoming.

Based on the information from received user actions 672, received device context 674, and perceived predictions 676, mode determination 278 can determine a corresponding goal/prioritization for charging that reflects the user's priority for using computing device 100. In other words, the user is not actively using computing device 100, computing device 100 is being charged, and a short plugin period is predicted for charging computing device 100. Accordingly, as shown in Table 1 above, based on the goal, mode determination 278 can determine an accelerated charging mode that corresponds to a unique combination of subsystem policies that can enable computing device to provide a better experience for the user (e.g., a fast charge), without the user having to make any explicit requests for the unique combination of subsystem policies. The corresponding policies call for an increase in charging speed (e.g., charge rate), an increase in thermal target temperatures, a decrease in package power target, as well as a decrease in background activity. Contextual power mode manager 137 can transmit signal(s) to corresponding subsystems 280 to enable the subsystem policies of the unique combination. In example 600, signal(s) can be transmitted to thermal controller 284 to allow an increase in the operating temperature of computing device 100. In other words, given that a short charging mode has been determined and computing device 100 is not in use, a user would be willing to accept computing device 100 becoming physically warmer for a faster charge. Contextual power mode manager 137 can also transmit a signal(s) to charging controller 286 to increase a charge rate. Contextual power mode manager 137 can transmit a signal(s) to CLPC 300 to reduce a package power target. Contextual power mode manager 137 can transmit a signal(s) to background activity scheduler 138 to decrease background activities.

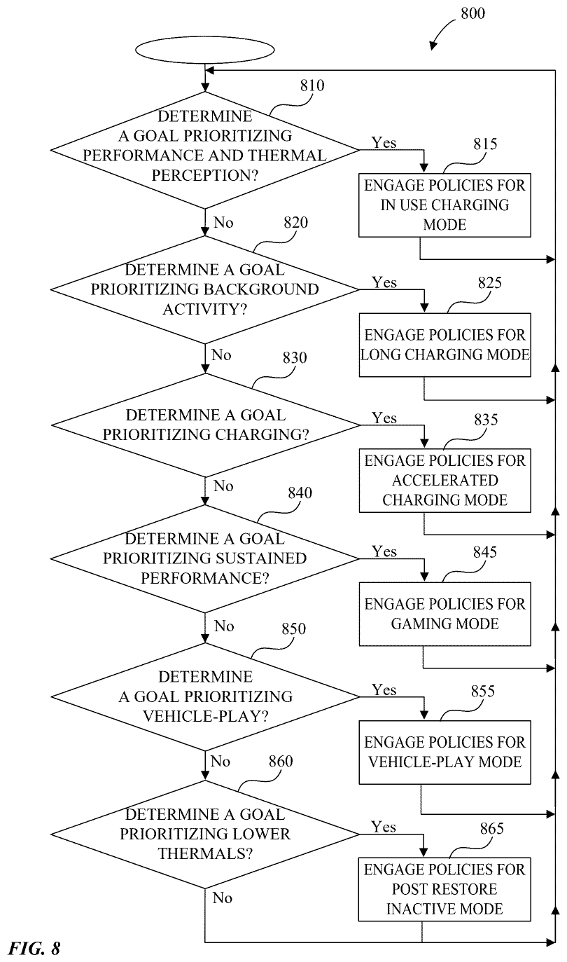

FIG. 8 illustrates method 800 for contextual power management based on goals, according to some embodiments of the disclosure. As a convenience and not a limitation, FIG. 8 may be described with reference to elements from other figures in the disclosure. For example, FIG. 8 can describe, at a high level, the determination of goals and prioritizations, modes, and the corresponding policies for corresponding subsystems described above, with reference to FIGS. 1-6. In some embodiments one or more processors of processor complex 111 support the functions of contextual power mode manager 137 that performs method 800.

At 810, contextual power mode manager 137 (e.g., mode determination 278) can determine whether a goal prioritizing performance and thermal perception has been determined. If a goal prioritizing performance and thermal perception has been determined (e.g., based on signals received from user actions 132, device context 133, and/or predictions 136), then method 800 proceeds to 815. Example 400 of FIG. 4 is an example of a goal prioritizing performance and thermal perception.

At 815, contextual power mode manager 137 engages policies for in-use charging mode. For example, contextual power mode manager 137 determines a unique combination of policies corresponding to the goal prioritizing performance and thermal perception, and transmits signals to the respective subsystems 280 to enable the unique combination so as to provide a better use experience for the user of computing device 100. As shown in Table 1 above, based on the goal, mode determination 278 can determine a mode, in-use charging that corresponds to a unique combination of subsystem policies that can enable computing device to provide a better experience for the user, without the user having to make any explicit requests for the unique combination of subsystem policies. The corresponding policies call for a decrease in charging speed (e.g., charge rate) as well as a decrease in background activity. Method 800 returns to 810.

At 820, contextual power mode manager 137 (e.g., mode determination 278) can determine whether a goal prioritizing background activity has been determined. If a goal prioritizing background activity has been determined (e.g., based on signals received from user actions 132, device context 133, and/or predictions 136), then method 800 proceeds to 825. Example 500 of FIG. 5 is an example of a goal prioritizing background activity.

At 825, contextual power mode manager 137 engages policies for long charging Mode. For example, contextual power mode manager 137 determines a unique combination of policies corresponding to the goal prioritizing background activity, and transmits signals to the respective subsystems 280 to enable the unique combination so as to provide a better use experience for the user of computing device 100. As shown in Table 1 above, based on the goal, mode determination 278 can determine a long charging mode corresponding to a unique combination of subsystem policies that can enable computing device to provide a better experience for the user, without the user having to make any explicit requests for the unique combination of subsystem policies. The corresponding policies call for a decrease in charging speed (e.g., charge rate), an increase in thermal target temperatures, a decrease in package power target, as well as an increase in background activity. Method 800 returns to 810.

At 830, contextual power mode manager 137 (e.g., mode determination 278) can determine whether a goal prioritizing charging has been determined. If a goal prioritizing charging has been determined (e.g., based on signals received from user actions 132, device context 133, and/or predictions 136), then method 800 proceeds to 835. Example 600 of FIG. 6 is an example of a goal prioritizing charging.

At 835, contextual power mode manager 137 engages policies for accelerated charging mode. For example, contextual power mode manager 137 determines a unique combination of policies corresponding to the goal prioritizing charging, and transmits signals to the respective subsystems 280 to enable the unique combination so as to provide a better use experience for the user of computing device 100. As shown in Table 1 above, based on the goal, mode determination 278 can determine an accelerated charging mode corresponding to a unique combination of subsystem policies that can enable computing device to provide a better experience for the user, without the user having to make any explicit requests for the unique combination of subsystem policies. The corresponding policies call for an increase in charging speed (e.g., charge rate), an increase in thermal target temperatures, a decrease in package power target, as well as a decrease in background activity. Method 800 returns to 810.

At 840, contextual power mode manager 137 (e.g., mode determination 278) can determine whether a goal prioritizing sustained performance has been determined. If a goal prioritizing sustained performance has been determined (e.g., based on signals received from user actions 132, device context 133, and/or predictions 136), then method 800 proceeds to 845. An example of user actions 132 may include determining that a particular type of application that uses high processing resources (e.g., video call application, AAA gaming application) is running on computing device 100.

At 845, contextual power mode manager 137 engages policies for gaming mode. For example, contextual power mode manager 137 determines a unique combination of policies corresponding to the goal prioritizing sustained performance, and transmits signals to the respective subsystems 280 to enable the unique combination so as to provide a better use experience for the user of computing device 100. As shown in Table 1 above, based on the goal, mode determination 278 can determine a gaming mode corresponding to a unique combination of subsystem policies that can enable computing device to provide a better experience for the user, without the user having to make any explicit requests for the unique combination of subsystem policies. The corresponding policies call for a decrease in charging speed (e.g., charge rate), an increase in thermal target temperatures, a decrease in package power target, as well as a decrease in background activity. In some examples, in gaming mode, some embodiments enable as much thermal headroom as possible to a system on a chip (e.g., CPU, GPU, and/or NE) so the device may be enabled to heat up more than normal before thermal controls are enacted. Method 800 returns to 810.

At 850, contextual power mode manager 137 (e.g., mode determination 278) can determine whether a goal prioritizing vehicle-play has been determined. If a goal prioritizing vehicle-play has been determined (e.g., based on signals received from user actions 132, device context 133, and/or predictions 136), method 800 proceeds to 855.

At 855, contextual power mode manager 137 engages policies for vehicle-play mode. For example, contextual power mode manager 137 determines a unique combination of policies corresponding to the goal prioritizing vehicle-play, and transmits signals to the respective subsystems 280 to enable the unique combination so as to provide a better use experience for the user of computing device 100. As shown in Table 1 above, based on the goal, mode determination 278 can determine a vehicle-play mode corresponding to a unique combination of subsystem policies that can enable computing device to provide a better experience for the user, without the user having to make any explicit requests for the unique combination of subsystem policies. The corresponding policies call for a decrease in charging speed (e.g., charge rate), a decrease in package power target, as well as a decrease in background activity. Vehicle-play mode may not be as much of an active use as gaming mode, thus, the thermal targets can be different. Method 800 returns to 810.

At 860, contextual power mode manager 137 (e.g., mode determination 278) can determine whether a goal prioritizing lower thermals has been determined. If a goal prioritizing lower thermals has been determined (e.g., based on signals received from user actions 132, device context 133, and/or predictions 136), then method 800 proceeds to 855.

At 865, contextual power mode manager 137 engages policies for post restore inactive mode (e.g., after a system update occurs). As shown in Table 1 above, based on the goal, mode determination 278 can determine a post restore inactive mode corresponding to a unique combination of subsystem policies that can enable computing device to provide a better experience for the user, without the user having to make any explicit requests for the unique combination of subsystem policies. The corresponding policies call for a decrease in charging speed (e.g., charge rate), a decrease in package power target, a decrease in package power target levels, with an increase in background activity. Method 800 returns to 810.

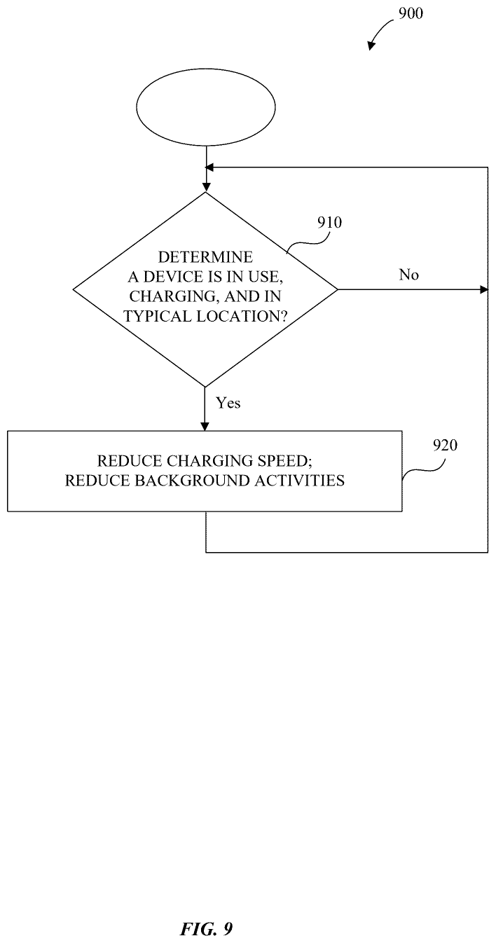

FIG. 9 illustrates method 900 for in-use charging mode contextual power management, according to some embodiments of the disclosure. As a convenience and not a limitation, FIG. 9 may be described with reference to elements from other figures in the disclosure such as FIGS. 1-8. Contextual power mode manager 137 can perform method 900. Method 900 can be a variation of an in-use mode (e.g., method 400) where the thermal control and the charge rate are linked. Signals to thermal controller 284 can include but are not limited to increasing or decreasing the temperature set point at which a charge rate is modified. Thus, the in-use mode prioritizes a positive thermal experience for the user while enabling performance for the user's applications while charging computing device 100. Thus, some embodiments use signals for user actions 132 (e.g., current usage), device context 133 (e.g., charging) and predictions 136 (e.g., device intelligence) to influence lower level subsystems 280 to choose alternate policies to offer an overall better experience for the user.

At 910, contextual power mode manager 137 can determine whether computing device 100 is in use, charging where the state of charge (e.g., battery charge) is greater than a given percentage (e.g., 20%) and in a typical charging location. In method 900, device context 133 determines based on charging state 454 and/or battery level 456 that computing device 100 is being charged and a state of charge is greater than a percentage of state of charge of 20%. If the determination confirms that computing device 100 is in use, charging where the state of charge is greater than the given percentage, and in a typical location, method 900 proceeds to 920. For example, based at least on information from received user actions 472, received device context 474, and perceived predictions 476, mode determination 278 can determine a corresponding goal/prioritization for performance and thermal perception that reflects the user's priority for using computing device 100.

Based on the goal, mode determination 278 can determine an in-use charging mode. The corresponding policies call for a decrease in charging speed (e.g., charge rate) as well as a decrease in background activity. In some examples, to reduce the charging rate, the one or more processors are further configured to determine that an in-use threshold has been satisfied, wherein the in-use threshold corresponds to: a temperature of the computing device, an in-use time period, an in-use time prediction, a workload, or a type of application running on the computing device (e.g., a vehicle-play application).

When contextual power mode manager 137 determines that computing device 100 does not satisfy the conditions (e.g., in use, charging and state of charge is greater than 20%, and in a typical location), method 900 returns to 910.

At 920, contextual power mode manager 137 can cause a reduction in charging speed (e.g., charging rate) and a reduction in background activities. For example, contextual power mode manager 137 can transmit signal(s) to charging controller 286 to reduce a charge rate. For example, a range for decreasing a charge rate for computing device can be 36° C. to 39° C. When computing device 100 is wired, contextual power mode manager 137 can transmit a signal to charging controller 286 to reduce the charge rate when the temperature of computing device 100 reaches 38° C. When computing device 100 is charging wirelessly, computing device 100 may transmit a signal to continue to operate according to the default policy. Contextual power mode manager 137 can transmit a signal(s) to background activity scheduler 138 to reduce background activities. For example, contextual power mode manager 137 can reduce background activities for a corresponding time period in the range of 10-30 minutes. For example, contextual power mode manager 137 can cause background activity scheduler 138 to schedule no background activity for 15 minutes.

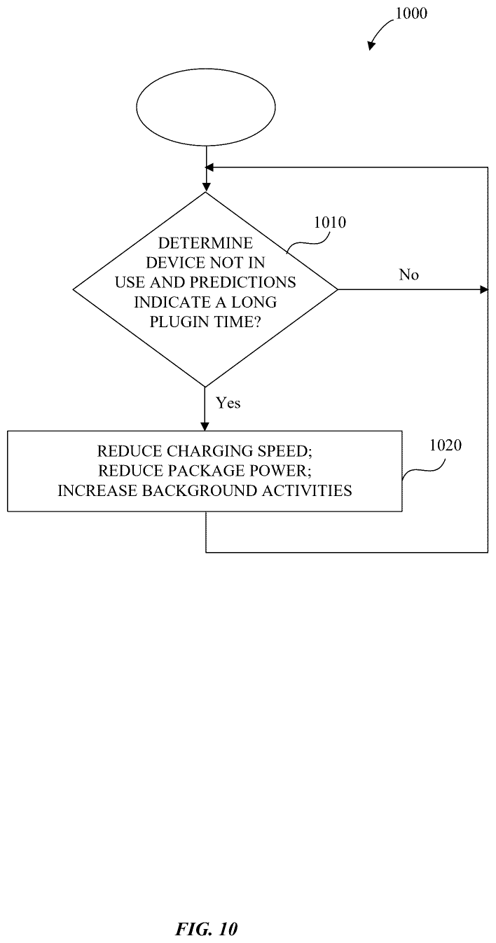

FIG. 10 illustrates a method for long charging mode contextual power management, according to some embodiments of the disclosure. As a convenience and not a limitation, FIG. 10 may be described with reference to elements from other figures in the disclosure such as FIGS. 1-8. Contextual power mode manager 137 can perform method 1000. Method 1000 can be an embodiment of long charging mode (e.g., method 500) implementing charging policies where the thermal target is not affected.

At 1010, contextual power mode manager 137 can determine whether computing device 100 is not being used, and a long plugin period is predicted for charging computing device 100. If the determination confirms that computing device 100 is not being used, and a long plugin period is predicted for charging computing device 100, method 1000 proceeds to 1020. For example, based on information from received user actions 572, received device context 574, and perceived predictions 576, mode determination 278 can determine a corresponding goal/prioritization for background activity that reflects the user's priority for using computing device 100. Based on the goal, mode determination 278 can determine a long charging mode corresponding to a unique combination of subsystem policies. The corresponding policies call for a decrease in charging speed (e.g., charge rate), a decrease in package power target, as well as an increase in background activity. When contextual power mode manager 137 determines that computing device 100 does not satisfy the conditions (e.g., not in use and prediction for a long plugin time), method 1000 returns to 1010.

At 1020, contextual power mode manager 137 can cause a reduction in charging speed (e.g., charging rate), a reduction in package power target, and an increase in background activities. For example, contextual power mode manager 137 can transmit signal(s) to charging controller 286 to reduce a charge rate. For example, a range for decreasing a charge rate for computing device can be 36° C. to 39° C. When computing device 100 is wired, contextual power mode manager 137 can transmit a signal to charging controller 286 to reduce the charge rate when the temperature of computing device 100 reaches 38° C. When computing device 100 is charging wirelessly, computing device 100 may transmit a signal to continue to operate according to the default policy.

Contextual power mode manager 137 can transmit a signal(s) to CLPC 300 to reduce a package power target. For example, an acceptable package power target can include 1 W to 3 W. Contextual power mode manager 137 can transmit a signal(s) to CLPC 300 to reduce a package power target to 2 W or to equal a LPM package power target.

Contextual power mode manager 137 can transmit a signal(s) to background activity scheduler 138 to increase background activities. For example, contextual power mode manager 137 can increase background activities for a corresponding time period in the range of 10-30 minutes. For example, contextual power mode manager 137 can cause background activity scheduler 138 to schedule an increase in background activity for 15 minutes. In some embodiments, contextual power mode manager 137 can transmit a signal(s) to background activity scheduler 138 to align with a default policy.

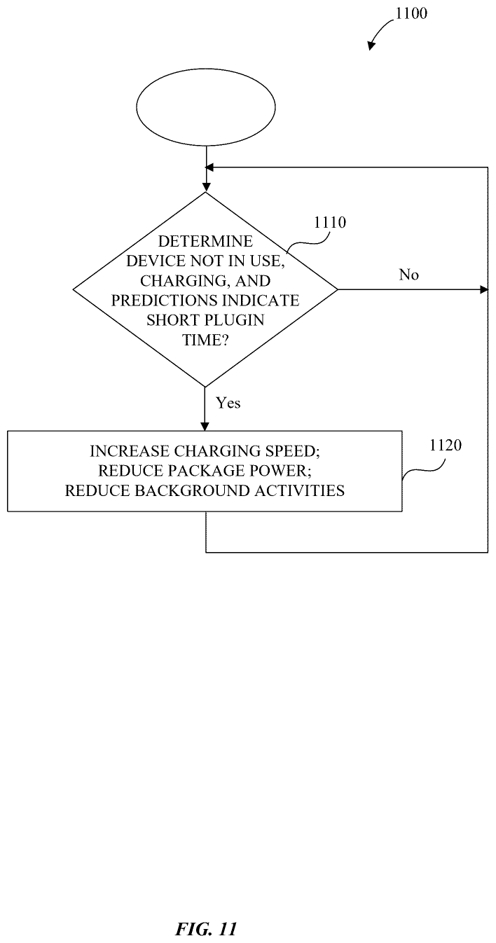

FIG. 11 illustrates a method for Accelerated Charging mode contextual power management, according to some embodiments of the disclosure. As a convenience and not a limitation, FIG. 11 may be described with reference to elements from other figures in the disclosure such as FIGS. 1-8. Contextual power mode manager 137 can perform method 1100. Method 1000 can be an embodiment of accelerated charging (e.g., method 600) where the thermal target is not affected.

At 1110, contextual power mode manager 137 can determine whether computing device 100 is not in use, is charging and the state of charge is less than or equal to a given percentage (e.g., 50%), where predictions indicate a short plugin time, and the determination occurs within the first X minutes of charging where X is an integer. In some examples, X=30. If the determination confirms that computing device 100 is not in use, is charging and the state of charge is less than or equal to a given percentage (e.g., 50%), where predictions indicate a short plugin time, and the determination occurs within the first X minutes of charging, method 1100 proceeds to 1120. For example, based on the information from received user actions 672, received device context 674, and perceived predictions 676, mode determination 278 can determine a corresponding goal/prioritization for charging that reflects the user's priority for using computing device 100. In other words, the user is not actively using computing device 100, the state of charge is less than or equal to 50%, a short plugin period is predicted for charging computing device 100, and the determination is made within the first 30 minutes of charging.

When contextual power mode manager 137 determines that computing device 100 does not satisfy the conditions (e.g., not in use, prediction for a short plugin time, state of charge is less than or equal to 50%, and determination is made within the first period of charge (e.g., first 30 minutes of charging), method 1100 returns to 1110.

At 1120, contextual power mode manager 137 can cause an increase in charging speed, reduce package power targets, and reduce background activities. Accelerated charging mode corresponds to a unique combination of subsystem policies that can call for an increase in charging speed (e.g., charge rate), a decrease in package power target, as well as a decrease of background activity. Contextual power mode manager 137 can transmit a signal(s) to CLPC 300 to reduce a package power target. For example, an acceptable package power target can include 300 mW to 1 W. Contextual power mode manager 137 can transmit a signal(s) to CLPC 300 to reduce a package power target to 1 W or to equal a package power target for computing device 100 not being in use. In some embodiments, contextual power mode manager 137 can cause no background activity to be scheduled. In some embodiments, the charging speed corresponds to the respective wired default policy of wireless default policy.

FIG. 12 is an example computer system for implementing some embodiments or portion(s) thereof. Various embodiments can be implemented, for example, using one or more well-known computer systems, such as computer system 1200 shown in FIG. 12. Computer system 1200 can be any well-known computer capable of performing the functions described herein. For example, and without limitation, computer system 1200 may include a SoC, and may perform functions described in: FIGS. 1-6, and can perform methods 700, 800, 900, 1000, and 1100 of FIGS. 7-11 respectively. Other apparatuses and/or components shown in the figures may be implemented using computer system 1200, or portions thereof.

Computer system 1200 includes one or more processors (also called central processing units, or CPUs), such as a processor 1204. Processor 1204 is connected to a communication infrastructure 1206 that can be a bus. One or more processors 1204 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1200 also includes user input/output device(s) 1203, such as monitors, keyboards, pointing devices, etc., that communicate with communication infrastructure 1206 through user input/output interface(s) 1202. Computer system 1200 also includes a main or primary memory 1208, such as random access memory (RAM). Main memory 1208 may include one or more levels of cache. Main memory 1208 has stored therein control logic (e.g., computer software) and/or data. Processor 1204 can be communicatively coupled to main memory 1208, for example.

Computer system 1200 may also include one or more secondary storage devices or memory 1210. Secondary memory 1210 may include, for example, a hard disk drive 1212 and/or a removable storage device or drive 1214. Removable storage drive 1214 may be a floppy disk drive, a magnetic tape drive, a compact disk drive, an optical storage device, tape backup device, and/or any other storage device/drive.

Removable storage drive 1214 may interact with a removable storage unit 1218. Removable storage unit 1218 includes a computer usable or readable storage device having stored thereon computer software (control logic) and/or data. Removable storage unit 1218 may be a floppy disk, magnetic tape, compact disk, DVD, optical storage disk, and/any other computer data storage device. Removable storage drive 1214 reads from and/or writes to removable storage unit 1218 in a well-known manner.

According to some embodiments, secondary memory 1210 may include other means, instrumentalities or other approaches for allowing computer programs and/or other instructions and/or data to be accessed by computer system 1200. Such means, instrumentalities or other approaches may include, for example, a removable storage unit 1222 and an interface 1220. Examples of the removable storage unit 1222 and the interface 1220 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1200 may further include a communication or network interface 1224. Communication interface 1224 enables computer system 1200 to communicate and interact with any combination of remote devices, remote networks, remote entities, etc. (individually and collectively referenced by reference number 1228). For example, communication interface 1224 may allow computer system 1200 to communicate with remote devices 1228 over communications path 1226, which may be wired and/or wireless, and which may include any combination of LANs, WANs, the Internet, etc. Control logic and/or data may be transmitted to and from computer system 1200 via communication path 1226.

The operations in the preceding embodiments can be implemented in a wide variety of configurations and architectures. Therefore, some or all of the operations in the preceding embodiments may be performed in hardware, in software or both. In some embodiments, a tangible, non-transitory apparatus or article of manufacture includes a tangible, non-transitory computer useable or readable medium having control logic (software) stored thereon is also referred to herein as a computer program product or program storage device. This includes, but is not limited to, computer system 1200, main memory 1208, secondary memory 1210 and removable storage units 1218 and 1222, as well as tangible articles of manufacture embodying any combination of the foregoing. Such control logic, when executed by one or more data processing devices (such as computer system 1200), causes such data processing devices to operate as described herein.

Based on the teachings contained in this disclosure, it will be apparent to persons skilled in the relevant art(s) how to make and use embodiments of the disclosure using data processing devices, computer systems and/or computer architectures other than that shown in FIG. 12. In particular, embodiments may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the disclosure as contemplated by the inventor(s), and thus, are not intended to limit the disclosure or the appended claims in any way.

While the disclosure has been described herein with reference to exemplary embodiments for exemplary fields and applications, it should be understood that the disclosure is not limited thereto. Other embodiments and modifications thereto are possible, and are within the scope and spirit of the disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative embodiments may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the disclosure should not be limited by any of the above-described exemplary embodiments, but should be defined only in accordance with the following claims and their equivalents.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A computing device, comprising:
a memory; and
one or more processors communicatively coupled to the memory, wherein the one or more processors are configured to:
determine a goal based at least on user actions, a device context, and predictions of the computing device;
based at least on the goal, determine one or more policies that affects one or more corresponding subsystems; and
transmit a signal to enable a policy of the one or more policies.

2. The computing device of claim 1, wherein to determine the goal, the one or more processors are configured to:
determine that the computing device is in use; and
determine a charging state of the computing device.

3. The computing device of claim 1, wherein the one or more policies comprise:
a reduction in a charging rate of a charging subsystem of the one or more corresponding subsystems; and
a reduction in background activity of a background activity subsystem of the one or more corresponding subsystems.

4. The computing device of claim 3, wherein to reduce the charging rate, the one or more processors are further configured to determine that an in-use threshold has been satisfied, wherein the in-use threshold corresponds to: a temperature of the computing device, an in-use time period, an in-use time prediction, a workload, or a type of application running on the computing device.

5. The computing device of claim 3, wherein to reduce the background activity, the one or more processors are further configured to establish a time duration during which no background activity is scheduled, or reduce a scheduling priority of background activity compared to in-use activity.

6. The computing device of claim 1, wherein the one or more processors are further configured to:
determine that the computing device is not in a typical charging location; and
based at least on the device not being in the typical charging location, reduce a power target of a performance controller.

7. The computing device of claim 1, wherein, the one or more processors are further configured to:
prioritize sustained performance of the computing device;
based at least on the prioritized sustained performance, reduce a power target of a performance controller; and
based at least on the prioritized sustained performance, allow an increase in temperature of the computing device.

8. A method for a computing device, comprising:
determining a goal based at least on user actions, a device context, and predictions of the computing device;
based at least on the goal, determining one or more policies that affects one or more corresponding subsystems; and
transmitting a signal to enable a policy of the one or more policies.

9. The method of claim 8, wherein the determining the goal further comprises:
determining that the computing device is not in use; and
predicting that a long plugin charge is forthcoming, wherein the long plugin charge comprises a duration of greater than 90 minutes.

10. The method of claim 8, wherein the one or more policies comprise:
a reduction in a charging rate of the computing device;
an increase in a background activity of the computing device; and
a reduction in a power target of a performance controller.

11. The method of claim 10, wherein the reduction in the power target of the performance controller corresponds to a value in a range of 1 W to 3 W.

12. The method of claim 8, further comprising:
prioritizing background activity of the computing device; and
based at least on the prioritized background activity, allowing an increase in temperature of the computing device.

13. The method of claim 8, further comprising:
prioritizing lower thermals of the computing device; and
based at least on the prioritized lower thermals, reducing a temperature of the computing device.

14. A non-transitory computer-readable medium storing instructions that, upon execution by one or more processors of a computing device, cause the computing device to perform operations, the operations comprising:
determining a goal based at least on user actions, a device context, and predictions of the computing device;
based at least on the goal, determining one or more policies that affects one or more corresponding subsystems; and
transmitting a signal to enable a policy of the one or more policies.

15. The non-transitory computer-readable medium of claim 14, wherein the determining the goal comprises:
determining that the computing device is not in use;
determining a charging state of the computing device; and
predicting that a short plugin charge is forthcoming.

16. The non-transitory computer-readable medium of claim 15, wherein the charging state comprises a state of charge of a battery of the computing device of less than or equal to 50%.

17. The non-transitory computer-readable medium of claim 15, wherein the short plugin charge comprises a duration of less than or equal to 90 minutes.

18. The non-transitory computer-readable medium of claim 14, wherein the one or more policies comprise:
an increase in a charging rate of a charging subsystem of the one or more corresponding subsystems;
a reduction in a background activity of a background activity subsystem of the one or more corresponding subsystems; and
a reduction in a power target of a performance subsystem of the one or more corresponding subsystems.

19. The non-transitory computer-readable medium of claim 18, wherein to reduce the power target of the performance subsystem corresponds to a value in a range of 300 mW to 1 W.

20. The non-transitory computer-readable medium of claim 14, wherein the operations further comprise:
prioritizing charging of the computing device; and
based at least on the prioritized charging, allowing an increase in temperature of a thermal subsystem of the one or more corresponding subsystems according to the policy.
